(19) United States
(12) Patent Application Publication
(10) Pub. No.: US 2010/0226210 A1
(43) Pub. Date: Sep. 9, 2010

(54) Vigilante acoustic detection, location and response system

(76) Inventors: Thomas F. Kordis, Evergreen, CO (US); Fred McClain, Cardiff by the Sea, CA (US)

Correspondence Address: Mark J. Pandiscio;Pandiscio & Pandiscio, P.C., 470 Totten Pond Road, Waltham, MA, 02451-1914, US

(21) Appl. No.: 11/638,603

(22) Filed: Dec. 13, 2006

Related U.S. Application Data
(60) Provisional application No. 60/749,741, filed on Dec. 13, 2005.

(51) Int. Cl. G01S 3/80

(52) U.S. Cl. 367/127

(57) ABSTRACT

A system and method for detecting the exact location of an acoustic event, the system comprising a plurality of variably spaced sensors, wherein each sensor comprises an omnidirectional microphone for detecting the acoustic event; a global positioning system (GPS); and a transmitter receiver for transmitting (i) the time that the acoustic event arrived at a particular sensor and (ii) the location of the particular sensor at the time the acoustic event arrived at the particular sensor; and a central processor radio-linked to the plurality of variably spaced sensors comprising a software program comprising at least one algorithm for determining the location of the acoustic event.

### REFERENCE TO PENDING PRIOR PATENT APPLICATION

This patent application claims benefit of pending prior U.S. Provisional Patent Application Ser. No. 60/749,741, filed Dec. 13, 2005 by Thomas Kordis et al. for VIGILANTE ACOUSTIC DETECTION, LOCATION AND RESPONSE SYSTEM (Attorney's Docket No. KORDIS-5 PROV).

### FIELD OF THE INVENTION

This disclosure describes a new acoustic system suitable for the rapid, accurate detection and location of a sudden acoustic event such as a gunshot from a sniper or an explosion. This system falls into the category of a muzzle blast detection system as described in the next section. However new and unique features have been incorporated into both the hardware and software of this system that provide several significant improvements over competitive systems.

The unique features of this system include:
The ability to calculate the location of a sniper or acoustic event rapidly (i.e., in approximately one second).
An order of magnitude improvement in the accuracy of the calculated solution when compared with competitive acoustic systems.
The ability to immediately detect and ignore echo signals. This feature allows the use of this system in “acoustically complex” environments such as urban warfare.
The ability to assign a “level of confidence” metric to the quality of the solution.
The ability to be fabricated in a light-weight, battery operated, portable system.
On the occasions when a retaliatory mortar or grenade round is fired, the ability to determine the precise location of that round's explosion, thereby providing precise targeting corrections to an operator.
An extensive redundancy in the system resulting in a remarkable robustness under combat conditions.
The elimination of “poor solution zones” that are associated with trigonometric and triangulation calculations.
The ability to automatically compensate for environmental factors (such as winds, temperature, altitude and humidity) that introduce errors into acoustic systems.
The ability to deploy miniature independent sensors in the midst of combat conditions or in preparation for an evening's encampment in the field.

These features will be discussed in detail when the system is described below.

### BACKGROUND OF THE INVENTION

### Patent Review

TABLE 1
Prior Patents

| | | |
|---|---|---|
| 6,621,764 | Smith | Weapon location by acoustic-optic sensor |
| | | fusion |
| 6,496,593 | Krone | Optical muzzle blast detection and |
| | | counterfire targeting system and method |
| 6,215,731 | Smith | Acousto-optic weapon location system |
| | | and method |
| 6,178,141 | Duckworth | Acoustic counter-sniper system |
| 5,973,998 | Showen | Automatic real-time gunshot locator |
| | | and display system |
| 5,970,024 | Smith | Acousto-optic weapon location system |
| | | and method |
| 5,930,202 | Duckworth | Acoustic counter-sniper system |
| 5,917,775 | Salisbury | Apparatus for detecting the discharge |
| | | of a firearm and transmitting an |
| | | alerting signal to a predetermined |
| | | location |
| 5,781,505 | Rowland | System and method for locating a trajectory |
| | | and a source of a projectile |
| 5,586,086 | Permuy | Method and a system for locating a firearm |
| | | on the basis of acoustic detection |
| 5,703,835 | Sharkey | System for effective control of urban |
| | | environment security |
| 5,544,129 | McNelis | Method and Apparatus for determining the |
| | | general direction of the origin of a |
| | | projectile |
| 5,528,557 | Horn | Acoustic Emission source location by |
| | | reverse ray tracing |
| 5,504,717 | Sharkey | System for effective control of urban |
| | | environment security |
| 5,455,868 | Sergent | Gunshot detector |
| 4,885,725 | McCarthy | Position measuring apparatus and method |
| 4,279,027 | Van Sloun | Acoustic sensor |
| 4,091,366 | Lavallee | Sonic monitoring method and apparatus |
| 3,979,712 | Ettenhofer | Sensor array acoustic detection system |
| 3,936,822 | Hirschberg | Method and apparatus for detecting weapon |
| | | fire |

### PRIOR ART

In past attempts at detecting sniper fire, inventors have attempted to detect one or more of several events that result from the firing of a gun. Passive systems, such as the muzzle blast, the muzzle flash and the supersonic shockwave systems, attempt to detect acoustic or electromagnetic energy that is emitted by the firing of a gun, or by the passage of the bullet through the air.

Active systems, such as the Laser system, infuse a volume of space with laser energy, attempting to detect laser energy reflected off of the bullet or the sniper's telescope. Other laser systems attempt to detect other indications (heat or air vortices) of the passage of a bullet through the air.

TABLE 2
Various sniper detecting systems

| System | Detection Description |
|---|---|
| Muzzle | Acoustically detects the sound of the muzzle blast through |
| blast | an array of microphones. By knowing the positions of the |
| system | microphones and the times at which the sound arrived at |
| | each, these systems use a variety of mathematical algorithms |
| | to calculate the origin of the sound. |
| Muzzle | These systems optically detect the heat and/or light emitted |
| flash | from the muzzle of a rifle. The heat and light are created by |
| system | the explosion of the bullet's gunpowder and by the friction of |
| | the bullet as it moves down the barrel of the rifle. These |
| | gasses are released into the air as the bullet emerges from the |
| | barrel of the rifle. |
| Super- | As a high velocity (i.e., supersonic) bullet travels through the |
| sonic | air it will shed a miniature shockwave akin to a tiny sonic |
| shock | boom. This shockwave can be detected by a dispersed array |
| wave | of microphones. By measuring the times at which these |
| system | shockwaves arrive at the microphones, a computer can |
| | attempt to determine the bullet's position in space at a |
| | succession of times. If calculated accurately, these position |
| | and time calculations can be assembled into a trajectory. An |
| | operator can compare this three dimensional trajectory to the |
| | local terrain and attempt to determine a likely origin of the |
| | bullet. |
| Active | An active laser system performs a very high speed raster |
| Laser | scan of a volume of space that is expected to be a source of |
| Systems | gunfire. If a bullet enters that volume of space, this system |
| | attempts to bounce its beam off of the bullet and to detect |
| | reflected laser light. By bouncing the laser off of the bullet |
| | from multiple locations, the bullet's location in space may be |
| | calculated (with limited accuracy). By obtaining a |
| | succession of reflected signals, a trajectory may be |
| | calculated. |
| | A second laser system attempts to detect the heating of the |
| | air caused by the passage of the bullet (and subsequent |
| | cooling). Air vortices caused by the passage of the bullet |
| | may also be detected. |
| | A third system attempts to obtain a reflected signal off of the |
| | sniper's telescope. |
| Combo | Due to strengths and weaknesses of each system, several |
| systems | manufacturers are combining two or more of the above |
| | systems into a single, integrated system. |

### Strengths and Weaknesses of Various Systems

Shock Wave Detectors

These systems try to detect the mini-shock wave off of a supersonic projectile, track the projectile in space (multiple sites in space) and reconstruct the projectile's motion in space, then project that space curve back to the origin of the shot. Since the shock wave is continuously generated as the bullet moves through space, it is computationally very intensive to reconstruct the projectile's path.

Advantages:
For high velocity (i.e., supersonic) bullets, this system is less sensitive to false alarms. This is due to the characteristic “double clap” of the shockwave followed by the muzzle blast. This signature is absent from most other explosive events.

Disadvantages:
This system does not determine the origin of the sound. Instead it attempts to determine successive positions of the bullet in three dimensional space at a distance far removed from the sensors. This succession of position measurements is assembled into a trajectory. It can be appreciated that small errors in the measurement of the successive positions can result in a very large error in the calculated trajectory.
The calculated trajectory of the bullet does not determine the bullet's origin. An operator must intervene to overlay the trajectory onto the local terrain in order to determine a likely origin of the bullet. For this reason, shockwave systems are frequently combined with other systems to assist in determining the actual origin of the bullet.
This system can be defeated by using a silencer on the rifle, since silencers drop the speed of even high velocity bullets below Mach 1.
Supersonic bullets will no longer be detected if they drop below Mach 1 during flight.
It is expensive.
It is not very portable. Most systems are vehicle mounted.
It uses considerable amounts of power, and is not well suited to battery operation.
It requires timing accuracies on the order of microseconds or better to achieve reasonable accuracy.

### Muzzle Flash Detector Systems

As mentioned above, this system attempts to detect the light and/or heat of the explosive gasses that propel the bullet down the muzzle when the gun is fired. As the bullet leaves the barrel, these gasses also discharge from the end of the barrel.

Advantages:
The main advantage of this system is its immunity from being degraded by ambient noise. This is a considerable advantage in the noisy environment of a modern military vehicle.

Disadvantages:
This system can be defeated by a flash suppressor. It can also be defeated by standard sniper tactics, such as shooting from within an enclosed structure as opposed to poking one's gun out into a position visible to surrounding personnel.
In order for this system to work, its optics must be pointed in the general direction of the sniper at the instant the bullet is fired. The system is not inherently omnidirectional, and currently available systems have only 120° fields of view, leaving ⅔ of the surrounding unmonitored and therefore undefended.
This system only provides relative bearing and azimuth information. No range information is calculated. This can be supplemented with a laser range-finder, but this adds complexity to the overall system.
This system can be spoofed by glints and reflections.
This system is generally bulky, complex, power consuming and expensive.

### Active Laser Detection Systems

The active laser detection system is a complex, expensive and rather desperate method of protecting limited volumes of space for limited amounts of time. It faces several extreme technological challenges, and its very existence merely emphasizes the extreme measures the military is willing to go in order to find some sort of a workable solution.

Advantages
This system is not compromised by ambient noise.

Disadvantages:
This system must flood a suspected volume of space with an extremely high speed, raster scanning laser.
This system and operator must have some knowledge of likely sources of sniper fire in order to protect the correct space.
Multiple detectors must surround the protected space.
The probability of obtaining a sufficient number of reflections off of a bullet to allow the calculation of a trajectory is very low in typical combat conditions.
This system suffers the same accuracy problems that all trigonometric and triangulation systems suffer.
This system is not amenable for use in mobile applications.
This system is bulky, expensive, and draws large amounts of power.

### Combination Systems

Many of the systems that are being fielded incorporate two or more of the various systems described above. There are several reasons to take this approach. By incorporating multiple systems, chance alone marginally increases the probability of detection of a sniper shot over the probability of any one system alone. Some of the systems provide only bearing and azimuth information and an auxiliary system is required to determine the range. Some of the trajectory calculating systems are subject to large errors in the point of origin due to relatively small errors in the calculation of the bullet's successive position in space. The auxiliary systems can improve the system's automatic response and eliminate the operator's required intervention to determine the trajectory's likely origin.

Advantages:
Marginally better results can be obtained compared to any single subsystem.
Since the various subsystems have their own weaknesses, the combination system will be more resistant to any single spoofing tactic.

Disadvantages
These systems are bulky, expensive and power drains.
These systems suffer mobility and power limitations worse than its least mobile and most power hungry component.
Competitive manufacturers must cooperate to cross-license technology.
Complexity is the enemy of reliability.

### Previous Muzzle Blast Detector Systems

Method of Calculation of Location of Origin of Sound

All previous acoustic systems use two mathematical steps to calculate the source of the sound. Note that the Vigilante system uses neither of these techniques.
Determination of the planar bearing angle and included cone angle, using the trigonometric Equations 1 & 2 below.
Triangulation of multiple bearing angle solutions from multiple microphone pairs. (Or triangulation's mathematical equivalent, the solving of multiple simultaneous equations to find a unique solution.)

The first technique uses the timing delay of the sound's arrival at one microphone with respect to the other microphone in order to generate a planar bearing angle according to Equation 1 below.

Ø=sin⁻¹(vₛ*Δt/d) [Equation 1]

### Where

Ø=in plane bearing (degrees)
vₛ=velocity of sound (approx. 1087 ft/sec)
Δt =sound arrival time difference (seconds)
d=distance between sensors (feet)
sin⁻¹=Arcsine Function

This planar bearing angle is directly related to the included angle of a conic surface upon which the sound originated, according to the following formula.

Φ=180°−2Ø [Equation 2]

### Where

Φ=included angle of conic surface (degrees)
Ø=planar bearing angle (degrees) as defined in Equation 1 above

The second mathematical process is triangulation. In this process, four or more conic surfaces are calculated from microphone pairs at different locations with their microphone axes at mutually oblique angles. The intersection of all of these surfaces is then reported as the location of the sniper.

Both of these processes have specific weaknesses that will now be discussed.

Calculation of Planar Bearing Angle

A single pair of microphones is used to detect the differential time that a sound arrives at each microphone. This is similar to the way that human hearing detects the direction from which a sound arrives. Note that no information is available on the range to the source of the sound, only an approximate direction (i.e., bearing and azimuth). If we assume the speed of sound to be 1087 feet per second, then sound travels 1.087 feet (approximately 13″) in one millisecond. For simplicity, let us assume that a typical sound detection scheme places its microphones this distance apart. A coordinate axis is constructed as shown in FIG. 1.

Given a measured time delay of a signal's arrival at two sensors (−d/vₛ<Δt<d/vₛ), the set of all points in a plane from which a sound could have originated can be approximated by a cone whose included angle is defined by the time delay of the signal. This cone has its tip at the midpoint of the axis joining the microphones, and its central axis is collinear with the microphone axis, as shown in FIG. 2 (top view) and FIG. 3 (isometric view). Note that the planar bearing angle to the sniper is 60°, and that the conic surface included angle (=180°−Ø) is also equal to 60°.

Note that the conic section extends infinitely to the right in FIG. 2, and that, as far as the single microphone pair can determine, the source of the sound could occur at any point on this conic surface.

Triangulation to Determine Sound Origin

A second pair of microphones at some oblique angle (typically 90°) to the first generates a second cone upon which the sound could have originated. The intersection of these two cones represents two straight lines in space. With two pairs of sensors, the source of the sound has now been determined to be somewhere on one of these two lines.

A third pair of sensors arranged 90° to the first two pairs can now generate a third cone. This third cone intersects the two previously determined lines at two points.

A fourth pair of sensors allows the elimination of one of the two possible points. The remaining point is the theoretical source of the sound.

### Imprecision #1: Trigonometric Planar Bearing Angle Calculation

A brief aside is required to show a fundamental problem that arises due to the use of the Arcsine Function in order to determine the Bearing Angle from the time delay, as described in Equation 1 above.

### Well-Behaved and Ill-Behaved Transfer Functions

A well-behaved transfer function is one that has an approximately constant sensitivity of the output (Bearing Angle, in this case) to input (time delay). The sensitivity can be quantified as the Slope of the output-input curve. FIG. 4 shows an example of an ideal transfer function, a Linear Transfer function.

Notice in FIG. 4 that there is a linear relationship between the output Y (e.g., bearing angle) and the input x (e.g., the non-dimensional quantity x=vₛ*Δt/d). Also note that the slope (i.e., sensitivity) of the relationship is a constant. In this case, the slope=K=90 throughout the entire range of x values (0≦x≦1).

In contrast to the well behaved linear transfer function described above, an Arcsine transfer function changes its behavior when the bearing angle exceeds about 70°. As shown in FIG. 5, the transfer function stays fairly well-behaved as long as x is less than approximately 0.9. However for values 0.95<x<1.0 (or bearing angles 70 °<Ø<90°), the output (the calculated bearing angle) becomes extremely sensitive to small changes in the input (x). This is clearly shown by the sudden steep rise of the slope of the arcsine curve. It is easy to see that, if the bearing angle is greater than 70°, any effect that introduces small errors into the timing signals (such as ambient winds) will also introduce large errors into the calculated bearing angle.

### Source of Timing Errors: Ambient Winds

Windage will be used as an example of a very real source of these timing errors. FIG. 6 shows the bearing errors that result from winds of 5, 10 and 15 knots.

### Imprecision #2: Projecting Bearing Angles

It is evident that even small bearing errors can result in large positional errors when they are projected out long distances. Table 3 below demonstrates how relatively modest bearing errors result in large positional errors when they are projected out long distances. The significant consequence of this analysis is that slight errors in the calculated bearing angle result in large positional errors when 1) the bearing angles are in the imprecise zones between 70°<Ø<90° and 2) those bearing errors are projected out the long distances that typically separate a sniper from a sniper detector.

TABLE 3
Wind Speed, Bearing Errors & Spatial
Errors For a single microphone pair

| Wind | Worst case | Bearing | Spatial Error | Spatial Error |
|---|---|---|---|---|
| speed | timing error | Error | @ 100 m | @ 500 m |
| 5 knot | 7.7 μseconds | ±4.6° @ 84° | ±8 m | ±40 m |
| 10 knot | 15.3 μseconds | ±7.1° @ 80° | ±12 m | ±62 m |
| 15 knot | 22.7 μseconds | ±8.5° @ 78° | ±15 m | ±75 m |

### Use of Orthogonal Pairs of Microphones

As mentioned above, any one pair of microphones generates an infinite number of possible locations for the origin of the sound. These locations are the conic surface shown in FIGS. 2 and 3.

Placing two pairs of microphones with their axes aligned at 90° to each other results in obtaining two cones whose intersection represents two straight lines in space. These two lines represent the reduced (but still infinite) number of possible locations for the origin of the sound.

However the problem of the errors associated with high bearing angles (Ø>70°) does not go away with crossed pairs of microphones. In fact, the problem is made worse. This is due to the fact that, for microphone pairs that are set at 90° to each other, sources that are in the “well-behaved” range of 0°<Ø₁<20° for the first pair of microphones will automatically be in the “ill-behaved” range of 70°<Ø₂<90° relative to the second pair of microphones, as shown in FIG. 7. When added together, two pairs of microphones oriented at 90° to each other results in four 40° zones of poor resolution, as shown in FIG. 7. In essence, fully 160° out of 360° (44%) of the entire bearing domain falls into these areas of poor resolution.

### Estimating Total Spatial Errors in Crossed Microphone Pair Systems

FIG. 8 shows the effect when the bearing errors noted above are combined for 2 orthogonal (i.e., 90°) sensor pairs and those bearing errors are projected out 152 meters (500 feet) from the sensor array. The error for the crossed pair microphone system is estimated by using the calculated Root Mean Square (RMS) error for the two individual sensor pairs at every 5° angle between 0° and 90°. These calculated errors are compared with the calculated errors from Vigilante's algorithm when evaluated under identical conditions. In this case, Vigilante's sensors have been randomly located at a range of 20 to 180 meters about the central processor. Note also that Vigilante's Wind Compensation algorithm has not been implemented for this analysis.

### SUMMARY OF THE INVENTION

The Vigilante Acoustic Location System detects and locates the source of a sudden acoustic event in three dimensional space (range, azimuth and bearing). That acoustic event might be the result of a natural event (e.g. lightning), an accident (e.g. an explosion at an oil refinery) or hostile military action (e.g. sniper attack, ambush or assault).

All Vigilante systems contain the following two components
1) an array of three to sixty four sensors equipped with GPS and a radio data link to the central processor.
2) a central processor with a data display running the custom Vigilante software.

The systems other than the man-portable Personal Defense System contain the following additional component.
3) a data link to an appropriate response subsystem, either lethal (e.g., computer controlled mortar battery) or non-lethal (e.g., pan & tilt, zoom video cameras).

The accuracy of the Vigilante system (Circular Probability of Error≦8 meters) permits tactical responses that were simply not possible with previous systems (CPE˜50 meters). In one preferred embodiment of the present invention, there is provided a system for detecting the exact location of an acoustic event, the system comprising:
a plurality of variably spaced sensors, wherein each sensor comprises:
   an omnidirectional microphone for detecting the acoustic event;
   a global positioning system (GPS); and
   a transmitter receiver for transmitting (i) the time that the acoustic event arrived at a particular sensor and (ii) the location of the particular sensor at the time the acoustic event arrived at the particular sensor; and
a central processor radio-linked to the plurality of variably spaced sensors comprising a software program comprising at least one algorithm for determining the location of the acoustic event.

In another embodiment of the present invention, there is provided a method for detecting the exact location of an acoustic event, the method comprising:
providing a system comprising:
   a plurality of variably spaced sensors, wherein each sensor comprises:
      an omnidirectional microphone for detecting the acoustic event;
      a global positioning system (GPS); and
   a transmitter receiver for transmitting (i) the time that the acoustic event arrived at a particular sensor and (ii) the location of the particular sensor at the time the acoustic event arrived at the particular sensor; and
   a central processor radio-linked to the plurality of variably spaced sensors comprising a software program comprising at least one algorithm for determining the location of the acoustic event;
transmitting (i) the time the acoustic event arrived at the particular sensor and (ii) the location of the particular sensor at the time the acoustic event arrived at the particular sensor to the central processor;
applying a first algorithm to the time and location of the particular sensor to generate an approximate location of the acoustic event; and
applying a second algorithm to the time and location of the particular sensor to detect the exact location of the acoustic event.

Those enhancements, along with several additional benefits are described below.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 illustrates a coordinate system for Vector based sonic location;

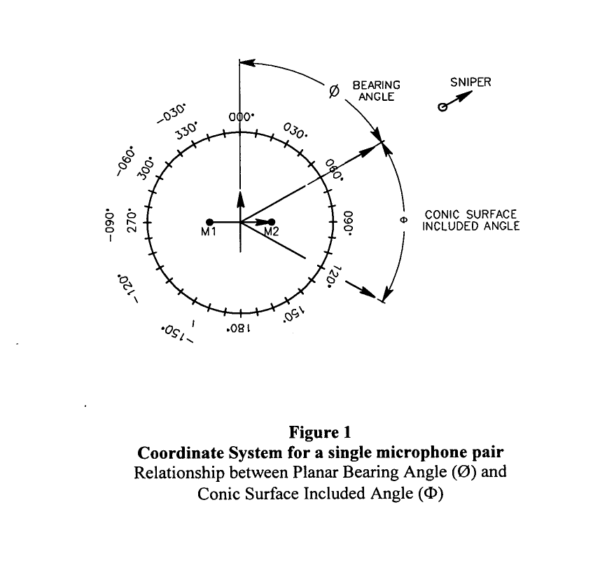

FIG. 2 is a top view of a bearing angle and conic surface;

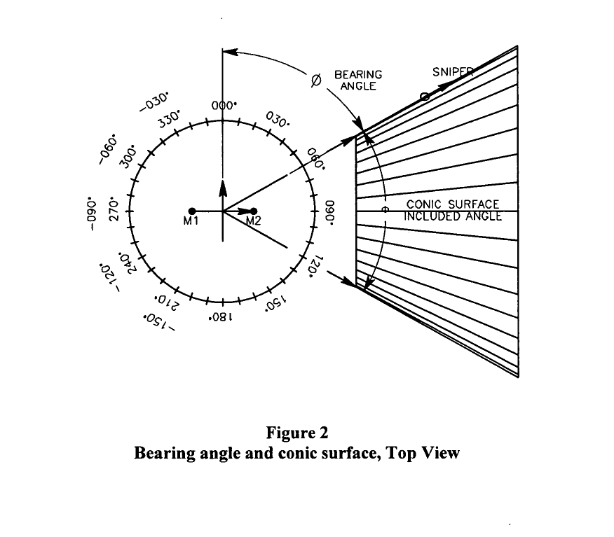

FIG. 3 is an isometric view of a bearing angle and conic surface;

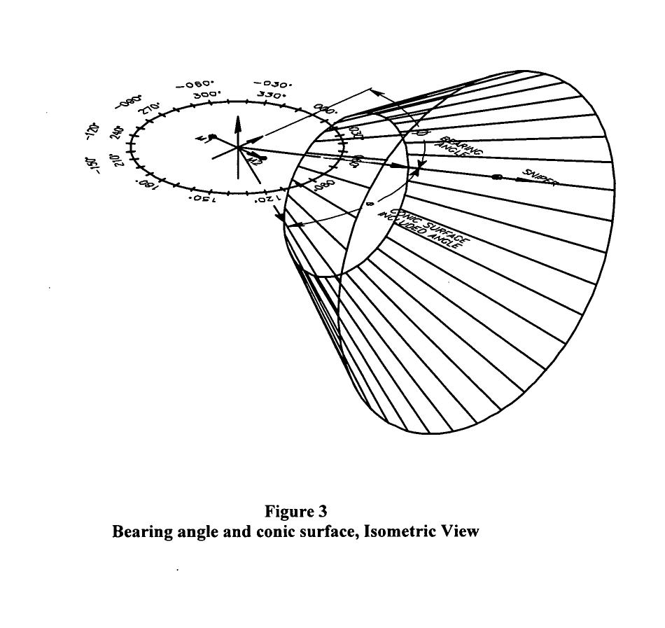

FIG. 4 is a graph illustrating a Linear Transfer Function;

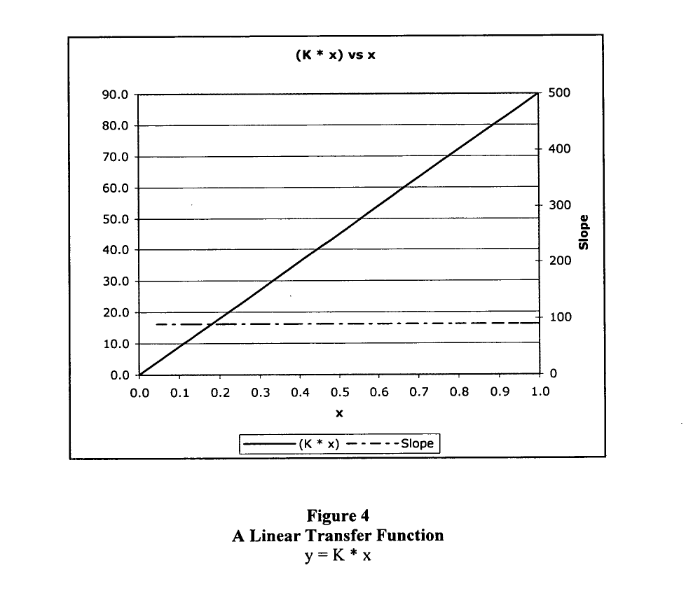

FIG. 5 is a graph illustrating an Arcsine Transfer Function;

FIG. 6 is a graph illustrating bearing errors due to windage;

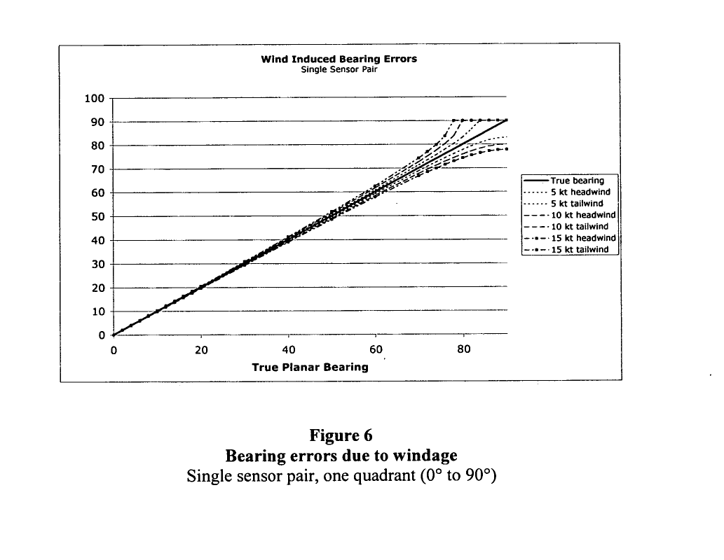

FIG. 7 illustrates zones of imprecision for 90° crossed microphone pairs;

FIG. 8 is a chart comparing Spatial Errors for Crossed microphone pairs vs. the present invention;

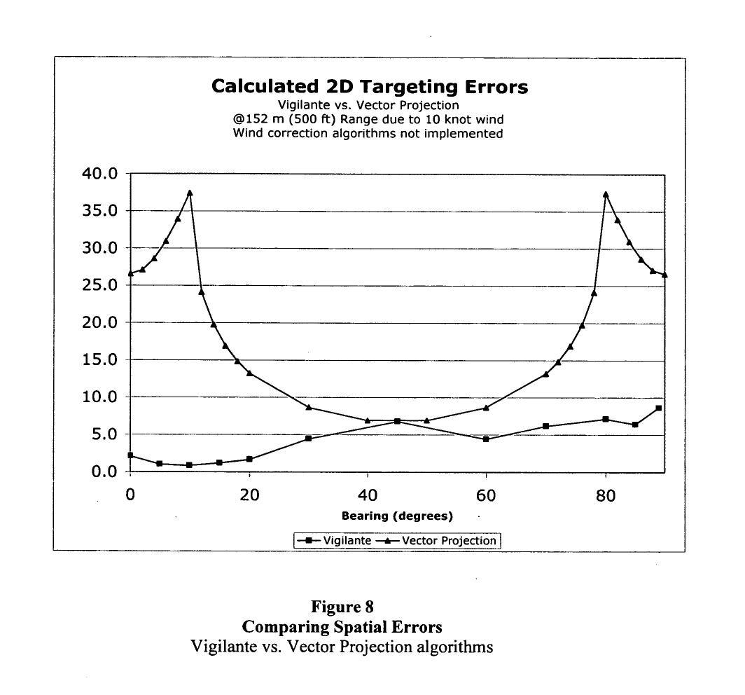

FIG. 9 illustrates the shockwave and muzzle blast peaks vs. time;

FIG. 10 illustrates an equilateral triad of microphones (S1, S2 & S3); and

FIG. 11 illustrates zones of imprecision for an equilateral triad of microphones.

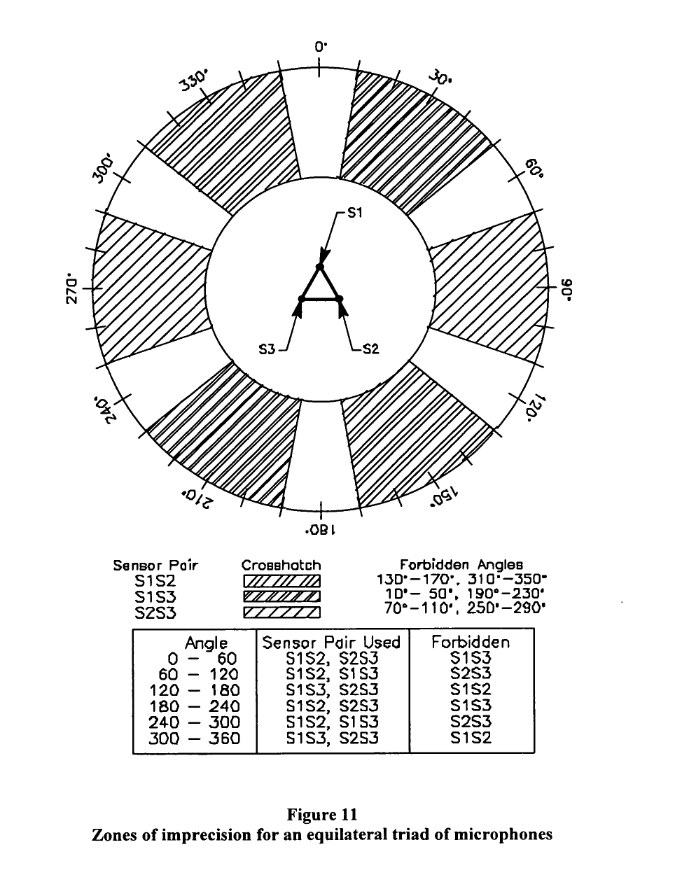

### DETAILED DESCRIPTION OF THE PREFERRED EMBODIMENTS

Vigilante comes in four configurations:
The Personal Defense System is designed to protect small numbers of foot soldiers when on maneuvers or encamped in potentially hostile territory.
The Convoy Defense System is designed to protect convoys or motorcades.
The Fixed Base Defense System is designed to protect outposts, buildings, embassies, depots or other large fixed bases of operation.
The Remotely Piloted Vehicle Defense System is designed to incorporate its sensors into small RPVs that will circle the protected asset under radio control of the central processor.

The component systems of each configuration are similar:
remote sensors with GPS location capability and a radio data link to the central processor
a central processor running the custom Vigilante software program, data linked to the remote sensors and to the response subsystem.
the response subsystem, which is available in either lethal (e.g., computer targeted mortar battery) or non-lethal (e.g., pan and tilt zoom cameras) configurations. (Note: Due to weight constraints, the response subsystem is not available on the Personal Defense System)

The Personal Defense System (Vigilante PDS)

The Personal Defense System is optimized for human portability. It consists of a tablet computer, the custom Vigilante software and a variable number (4 to 32) of personal and deployable sensors. (Upgrades to the system will allow more sensors and communication between multiple Vigilante systems.)
The central computer is a ruggedized version of commercially available tablet computers, weighing approximately 1 kilogram (˜2 pounds). The computer possesses a color display that can graph the locations of friendly and hostile personnel and a radio data link to the individual sensors.
The personal sensor is a battery powered, lightweight (˜14 ounce) electronics box approximately 4″×3″×0.75″ and a featherweight, helmet or shoulder mounted omnidirectional microphone. This sensor has a data input port for connection to a soldier's GPS locator, and a radio link to the central computer. The sensor also possesses pattern recognition software that helps it identify predefined acoustic fingerprints that would help it distinguish gunshots from other types of explosive events.
The deployable sensor is a robust, self-contained version of the personal sensor that can be deployed when needed. It is approximately the size of a tennis ball, and can be placed or thrown into appropriate locations without exposing the deploying personnel to hostile fire. The deployable sensor has a self-contained GPS capability, a built-in omnidirectional microphone and its own radio link to the central computer.

Whenever an event with the acoustic signature of a gunshot is detected, the computer calculates the precise location of the source of the sound. The absolute (GPS) location of the sniper as well as the location of all sensor-equipped friendly forces are plotted on the computer's display screen. In addition, the Range, Azimuth, Relative Bearing and Magnetic Bearing (RARB/MB) from any three sensor-equipped soldiers to the source can be instantly displayed. In responding to the sniper threat, this RARB/MB information can be relayed from the systems operator to the troops over existing radio communications links.

The Convoy Defense System (Vigilante CDS)

The Convoy Defense System consists of a laptop computer (with the Vigilante software installed) and a variable number of sensors (4 to 25) hard mounted, one to a vehicle.
The laptop computer is a ruggedized version of commercially available computers, temporarily or permanently mounted in one of the vehicles (the “command vehicle”) in the convoy.
The sensors are omnidirectional microphones and their associated electronics boxes. Each electronics box combines the function of microphone amplifier, noise suppression filter, GPS locator and data link to adjacent vehicles in the convoy. Electronic boxes are data-linked to each other and to the command vehicle. One sensor and electronics box is mounted onto each protected vehicle.
The response subsystem is an option for the Convoy Defense System that permits targeting data to be downloaded to a towed, computer targeted mortar battery. With sufficient computing power, “on the fly” firing of this mortar is possible.

### The Fixed Base Defense System (Vigilante FBS)

Fixed Base Defense System consists of a central computer system, the Vigilante software, an alarm system, a sensor array, an image acquisition system, an optional image storage system and an optional data output link.
The central computer system consists of a computer (laptop or desktop) with data input and output capabilities. The computer controls the entire system. It manages acoustic signal acquisition, sniper location calculation and display, alarm annunciation, camera motion, image acquisition and storage, and (if installed) counter-battery data output. Additional functions are system calibration and maintenance.
The alarm system is a group of local and/or remote annunciators that alert the systems operators to the acquisition of a “suspicious” acoustic signal.
The sensor array is a group of 6 to 64 omnidirectional microphones with custom electronics boxes. These sensors are hard mounted at pseudorandom locations dispersed along the periphery of the asset to be protected. The sensors communicate with the central computer through hardwire or radio links.
The image acquisition system is an array of 3 to 15 image acquisition devices and console displays. These devices consist of customer-determined video, photographic or low light cameras with zoom capabilities. Each camera will be mounted on a pan and tilt base to allow targeting on the source of the sound. The image signals are transmitted back to console displays in the control center through video cable or high speed data links.
The data output link allows the central computer to communicate the location of the sniper to other computer-targeted counter-batteries, such as mortars or grenade launchers.

The Remotely Piloted Vehicle Defense System (Vigilante RDS)

The Remotely Piloted Vehicle (RPV) Defense System is a modification of the Personal Defense System that mounts its sensors onto the body and/or a trailing wire of a small remotely piloted vehicle. The vehicle is GPS equipped and its flight-path is controlled via a radio data link by the central processor. In essence, the RDS is the Personal Defense System mounted onto low-noise RPVs. Flying overhead, the vehicles will generally receive a clear, line-of-sight muzzle blast the vast majority of the time. For this reason, only three RPVs will generally be needed, although a fourth RPV will improve accuracy and reliability of a solution.

### Vigilante System Software

The heart of Vigilante is the computer algorithm that calculates a precise location of the origin of a muzzle blast from the differential times that sound arrives at a dispersed array of acoustic detectors. This algorithm has been developed to surmount several of the problems associated with this calculation with past acoustic systems.

In order for a sniper location to be calculated, at least 3 line-of-sight signals must be acquired. The use of 4 through 6 data signals improves the accuracy and reliability of the calculation. Above 6 signals, solution accuracy does not significantly improve.

### Solution Method

Unlike previous systems, no direction vectors or triangulation methods are ever employed by the Vigilante algorithm. All acoustic sensors are purely omnidirectional, and no attempt is ever made to determine a relative bearing from any single or pair of sensors. The solution is purely mathematical.

It is difficult for most people to visualize more than three dimensions. Therefore in order to envision the solution method, three dimensional space (longitude, latitude and altitude) of a typical battlefield will be reduced to just two dimensions (x and y) of a flat plane. The third dimension (height above this plane) can now measure a specific, calculated value, referred to as the Timing Error, or TE(x,y). The “(x,y)” indicates that TE is a continuous function of both the x and y position on our flat plane.

When the sound from an acoustic “event” (such as a sniper's muzzle blast) is recorded by several of the dispersed sensors, the time of arrival of that sound and the specific location of that sensor at that instant are recorded and then transmitted via radio link to the central processor. Typically some subset of all the sensors (e.g., 12 out of 20) will detect the event. Of these sensors, a smaller subset (e.g., 8 out of 12) will receive a direct, line of sight signal from the muzzle blast. Some of the sensors (4 in this example) may be shielded from a direct line-of-sight signal, but instead receive a delayed echo signal that bounced off of some remote structure.

It is important to note that echo signals are always delayed compared to direct signals. Nonetheless, echo signals can completely fool traditional triangulation systems. But they can be instantly recognized and eliminated by the Vigilante algorithm. This will be described below.

The data that is transmitted from the sensors to the central processor consists of a matrix of [sensor number, sensor location, time of arrival of sound] for each sensor. Note that one sensor will always have the earliest time of arrival. For the purpose of our discussion, this sensor's time of arrival is designated t₀, and can be set to 0.000 seconds. All other sensor times will be measured in “seconds after t₀”. Note that the system has no information about the travel time of the sound between the muzzle of the gun and arrival at the closest sensor. Fortunately, this piece of information is not necessary in order to calculate an accurate source of the sound.

Given the matrix of raw data, several preliminary steps are taken to assure a robust solution. First, the location of each reporting sensor is examined, and a subset of 6 of those sensors is selected to ensure a well dispersed set of sensors. The use of widely spaced sensor data improves the accuracy of the solution. This subset of sensors is designated as the “Solution Sensor List”.

Second, a “characteristic equation” is generated using these six sensor data. This equation begins by designating an arbitrary Test Point on the (x,y) plane, designated as TP(x,y). Then the “time of arrival” from this test point (TP) to each of the sensors in the Solution Sensor List is calculated, normalized to the earliest sensor time t₀. This value is subtracted from the measured sum of the arrival times at each sensor in the Solution Sensor List, and its absolute value is taken. Then the sum of all absolute value errors is calculated, and referred to as the Summed Timing Error (STE).

In detail, the characteristic equation for six sensors is given by the following equation:

$$STE [ [ x , y ] ] = {( - t 1 + t 2 + \frac{\begin{matrix}\sqrt{{( xtp - x 1 )}^{2} + {( ytp - y 1 )}^{2} + {( ztp - z 1 )}^{2}} - \\ \sqrt{{( xtp - x 2 )}^{2} + {( ytp - y 2 )}^{2} + {( ztp - z 2 )}^{2}}\end{matrix}}{1087} )}^{2} + {( - t 1 + t 3 + \frac{\begin{matrix}\sqrt{{( xtp - x 1 )}^{2} + {( ytp - y 1 )}^{2} + {( ztp - z 1 )}^{2}} - \\ \sqrt{{( xtp - x 3 )}^{2} + {( xtp - y 3 )}^{2 } + {( ztp - z 3 )}^{2}}\end{matrix}}{1087} )}^{2} + {( - t 2 + t 3 + \frac{\begin{matrix}\sqrt{{( xtp - x 2 )}^{2} + {( ytp - y 2 )}^{2} + {( ztp - z 2 )}^{2}} - \\ \sqrt{{( xtp - x 3 )}^{2} + {( ytp - y 3 )}^{2} + {( ztp - z 3 )}^{2}}\end{matrix}}{1087} )}^{2} + {( - t 1 + t 4 + \frac{\begin{matrix}\sqrt{{( xtp - x 1 )}^{2} + {( ytp - y 1 )}^{2} + {( ztp - z 1 )}^{2}} - \\ \sqrt{{( xtp - x 4 )}^{2} + {( ytp - y 4 )}^{2} + {( ztp - z 4 )}^{2}}\end{matrix}}{1087} )}^{2} + {( - t 2 + t 4 + \frac{\begin{matrix}\sqrt{{( xtp - x 2 )}^{2} + {( ytp - y 2 )}^{2} + {( ztp - z 2 )}^{2}} - \\ \sqrt{{( xtp - x 4 )}^{2} + {( ytp - y 4 )}^{2} + {( ztp - z 4 )}^{2}}\end{matrix}}{1087} )}^{2} + {( - t 3 + t 4 + \frac{\begin{matrix}\sqrt{{( xtp - x 3 )}^{2} + {( ytp - y 3 )}^{2} + {( ztp - z 3 )}^{2}} - \\ \sqrt{{( xtp - x 4 )}^{2} + {( ytp - y 4 )}^{2} + {( ztp - z 4 )}^{2}}\end{matrix}}{1087} )}^{2} + {( - t 1 + t 5 + \frac{\begin{matrix}\sqrt{{( xtp - x 1 )}^{2} + {( ytp - y 1 )}^{2} + {( ztp - z 1 )}^{2}} - \\ \sqrt{{( xtp - x 5 )}^{2} + {( ytp - y 5 )}^{2} + {( ztp - z 5 )}^{2}}\end{matrix}}{1087} )}^{2} + {( - t 2 + t 5 + \frac{\begin{matrix}\sqrt{{( xtp - x 2 )}^{2} + {( ytp - y 2 )}^{2} + {( ztp - z 2 )}^{2}} - \\ \sqrt{{( xtp - x 5 )}^{2} + {( ytp - y 5 )}^{2} + {( ztp - z 5 )}^{2}}\end{matrix}}{1087} )}^{2} + {( - t 3 + t 5 + \frac{\begin{matrix}\sqrt{{( xtp - x 3 )}^{2} + {( ytp - y 3 )}^{2} + {( ztp - z 3 )}^{2}} - \\ \sqrt{{( xtp - x 5 )}^{2} + {( ytp - y 5 )}^{2} + {( ztp - z 5 )}^{2}}\end{matrix}}{1087} )}^{2} + {( - t 4 + t 5 + \frac{\begin{matrix}\sqrt{{( xtp - x 4 )}^{2} + {( ytp - y 4 )}^{2} + {( ztp - z 4 )}^{2}} - \\ \sqrt{{( xtp - x 5 )}^{2} + {( ytp - y 5 )}^{2} + {( ztp - z 5 )}^{2}}\end{matrix}}{1087} )}^{2} + {( - t 1 + t 6 + \frac{\begin{matrix}\sqrt{{( xtp - x 1 )}^{2} + {( ytp - y 1 )}^{2} + {( ztp - z 1 )}^{2}} - \\ \sqrt{{( xtp - x 6 )}^{2} + {( ytp - y 6 )}^{2} + ( ztp - z 6 )}\end{matrix}}{1087} )}^{2} + {( - t 2 + t 6 + \frac{\begin{matrix}\sqrt{{( xtp - x 2 )}^{2} + {( ytp - y 2 )}^{2} + {( ztp - z 2 )}^{2}} - \\ \sqrt{{( xtp - x 6 )}^{2} + {( ytp - y 6 )}^{2} + {( ztp - z 6 )}^{2}}\end{matrix}}{1087} )}^{2} + {( - t 3 + t 6 + \frac{\begin{matrix}\sqrt{{( xtp - x 3 )}^{2} + {( ytp - y 3 )}^{2} + {( ztp - z 3 )}^{2}} - \\ \sqrt{{( xtp - x 6 )}^{2} + {( ytp - y 6 )}^{2} + {( ztp - z 6 )}^{2} }\end{matrix}}{1087} )}^{2} + {( - t 4 + t 6 + \frac{\begin{matrix}\sqrt{{( xtp - x 4 )}^{2} + {( ytp - y 4 )}^{2} + {( ztp - z 4 )}^{2}} - \\ \sqrt{{( xtp - x 6 )}^{2} + {( ytp - y 6 )}^{2} + {( ztp - z 6 )}^{2}}\end{matrix}}{1087} )}^{2} + {( - t 5 + t 6 + \frac{\begin{matrix}\sqrt{{( xtp - x 5 )}^{2} + {( ytp - y 5 )}^{2} + {( ztp - z 5 )}^{2}} - \\ \sqrt{{( xtp - x 6 )}^{2} + {( ytp - y 6 )}^{2} + {( ztp - z 6 )}^{2}}\end{matrix}}{1087} )}^{2}$$

### Where:

{xi, yi, zi}=the coordinate position of sensors 1 through 6 respectively (i=sensor index number) (ft)
{t1, t2 . . . t6}=the times at which the sound arrived at each sensor S₁ thru S₆ (seconds)
{xtp, ytp, ztp}=the {x, y, z} coordinate of the test point (ft)
1087=the speed of sound in air at standard temp and pressure (feet per second).

### Advantages of the Algorithm

There are several distinct advantages to using this characteristic equation and a minimum finding routine. They include the following.
The characteristic equation can be written as:

$$STE [ [ x , y ] ] = Sum [ \begin{matrix}{( \begin{matrix}\frac{( \begin{matrix}p 2 p [ testPt , tPoint [ [ i ] ] ] - \\ p 2 p [ testPt , tPoint [ [ j ] ] ]\end{matrix} )}{vSound} - \\ ( testTime [ [ i ] ] - testTime [ [ j ] ] )\end{matrix} )}^{2} , \\ \{ i , numSensors - 1 \} , \{ j , i + 1 , numSensors \}\end{matrix} ]$$

### Where

Sum=function that sums the results in brackets.
p2p[[p1, p2]]=a function that gives the distance between points p1 and p2
numSensors=the number of sensors used. (In the above equation, numSensors=6)

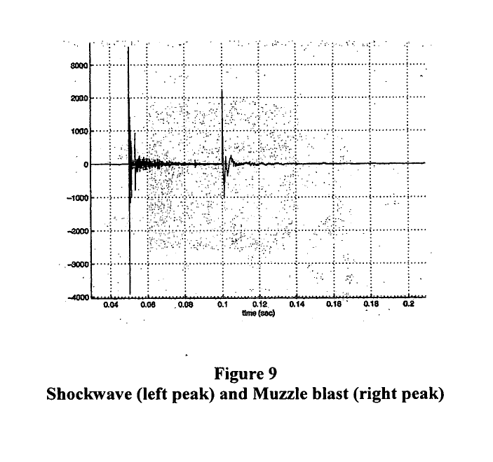

The advantage of writing this equation in this form is that the equation can be easily generated for any number of sensors used by simply changing the value of “numSensors”. For example, if the solution had to be found using only five sensors instead of six, setting numSensors=5 would generate the same equation shown in FIG. 9, but without the last five terms. The flexibility of this code for using any number of available sensors can be appreciated.
The logic behind the STE equation is that the first term in the equation (“−t1+t2”) in the first term in of STE (See FIG. 9) is the actual time difference between the sound arriving at sensor 1 and at sensor 2. The second term:

$$\frac{\begin{matrix}\sqrt{{( xtp - x 1 )}^{2} + {( ytp - y 1 )}^{2} + {( ztp - z 1 )}^{2}} - \\ \sqrt{{( xtp - x 2 )}^{2} + {( ytp - y 2 )}^{2} + {( ztp - z 2 )}^{2}}\end{matrix}}{1087}$$

is the time delay that would have resulted if the test point (tp) were at the actual sniper's location. Subtracting the first term from the second means that this entire term will go to a value of zero only if the test point is at the sniper's location.
This is the heart of the algorithm. A sophisticated search is conducted over the surrounding area evaluating STE at a sequence of points, looking for a minimum in the value of STE. This minimum may or may not be the sniper's true location. (See “Hanging Valleys” below.)

Note that the Summed Timing Error (STE) is a function of the (x,y) position on the two dimensional plane. Therefore STE is correctly written as STE(x,y). Note also that, since the timing error of each sensor pair is squared before those errors are summed, STE(x,y) is always a positive value. Finally, note one critical mathematical observation: STE(x,y) can be equal to zero at ONLY one location, the actual location of the origin of the sound. However, uncontrollable timing errors (such as echoes and winds) will prevent the STE value from actually getting to exactly zero in most cases. This is why a minimum searching algorithm is used instead of a “root finding” one.

It can be demonstrated that there exist a fair number of possible characteristic equations. The one described above has been chosen after running thousands of simulations for its success in arriving at accurate solutions in a brief amount of time, and its flexibility in selecting a varying number of sensors.

The characteristic equation used may be described as finding a location that matches theoretical delay times to the actual measured delay times for all permutations of four to six sensors. Four sensors would match S1-S2, S1-S3, S2-S3, S1-S4, S2-S4 & S3-S4. Five sensors would add to this list a matching delay for S1-S5, S2-S5, S3-S5 & S4-S5. Alternative characteristic equations could be described by the following conditions.
A ring of sensor delay times. Instead of matching the delay times for all sensor permutations, a reduced subset would be used. In this case, delay times would be matched for S1-S2, S2-S3, S3-S4, S4-S5, S5-S6 and S6-S1 only. This characteristic equation would produce a faster, but somewhat less accurate, solution.
Another alternate characteristic equation can be constructed by giving each sensor pair its own dimensional space. If combined with the ring of sensors characteristic equation described above, this would be mathematically equivalent to attaching unit vectors i, j, k, l, m, and n to the various time delay errors. This would generate a characteristic equation that had the following terms.

STE*(x,y,z)=((t1−t2)ₘ−(ttp:t1−ttp:t2)ₜ)i+((t2−t3)ₘ−(ttp:t2ₜ−ttp:t3ₜ))j++((t3−t4)ₘ−(ttp:t3ₜ−ttp:t4ₜ))k+ . . . +((t6−t1)ₘ−(ttp:t6ₜ−ttp:t1ₜ))n.

### Where

STE*(x,y,z)=the new characteristic equation.
(t1−t2)ₘ=measured delay time between arrivals at sensors 1 & 2.
ttp:t1ₜ=calculated delay time between test point tp and sensor 1.
ttp:t2ₜ=calculated delay time between test point tp and sensor 2.
i, j, k, l, m, and n=mutually orthogonal unit vectors.

The benefits of using this technique is that the individual delay times are matched as test point tp moves through three dimensional space, without one sensor's errors affecting any other sensor. Since there are only three degrees of freedom for tp to move through three dimensional space, a solution which brings the coefficients of each unit vector to zero will not generally be possible.

Nonetheless, a point that minimizes each coefficient independently will be found.

### Rolling Mathematical Marbles

Returning to the chosen characteristic equation, if we were to plot the Summed Timing Error [STE(x,y)] at each point on our flat plane, the resultant three-dimensional plot would appear as a terrain of rolling hills. The height of each point on the terrain would represent the Summed Timing Error. There would be only one point in the whole terrain at which the height would be zero. And that point would be the exact point that we were searching for—the position of the sniper shot or explosion.

There are a number of well-known algorithms for finding a “minimum” (i.e., lowest point) in a continuous two or three dimensional function such as the one that we have constructed. In essence, these algorithms find the absolute value of the STE(x,y) and also find the slope of the STE(x,y) function at an arbitrary test point (x_{TP}, y_{TP}). The steepness and the (x,y) direction of the steepest slope at Test Point TP is a vector quantity known as the Gradient of STE(x_{TP}, y_{TP}), and is expressed as Grad(STE(x_{TP}, y_{TP})). This vector defines the direction and acceleration that a ball placed at this point would begin to roll. The minimum searching algorithms in essence mimic the action of placing a ball onto the “virtual terrain” of STE(x,y) and allowing it to roll downhill to its lowest possible point. Fairly quickly, a minimum will be found.

It is NOT certain, however, that this particular minimum will be the correct solution. Additional mathematical measurements and intelligent search strategies are required to insure that the one correct solution is found.

### “Hanging Valleys” in the STE Terrain

It is possible that a minimum in the STE(x,y) function will NOT represent the true location of the sniper. Just as in the case of a hanging valley in geographical terrain, it is possible to have a low point in the STE(x,y) function that does not have a STE value equal to zero. At this point, the minimum searching routine is at an impasse. It cannot find its way to a real solution.

The method used by Vigilante to overcome this problem is to use several discrete starting points for the minimum searching routine. The action of rolling several balls down the STE(x,y) terrain, starting from several dispersed points, guarantees that one or more of the balls will not get trapped in a hanging valley, but will roll down to a true solution where STE(x,y) is approximately equal to zero. The Vigilante algorithm is smart enough to recognize this pitfall, and reports only true solutions where STE(x,y) is VERY close to a zero value.

### Figure of Confidence

The absolute value of the STE(x,y) function at the solution point represents a level of confidence in the solution. If this value is on the order of 10⁻⁶ seconds or less, then the solution is sure to be accurate. If this value is on the order of 10⁻³ seconds, then there is some uncertainty in this solution. If the value of the STE(x,y) function is on the order of 10⁻¹ seconds or greater, then there is sure to be an error in the solution due to an echo or other miscalculation. This value of STE(x,y) at the solution point is the source of Vigilante's “Figure of Confidence” that is reported to the system operator.

If the solution quality is below preset levels, the software will automatically attempt to calculate an improved solution.

Whenever a sniper location solution is presented to the systems operator, a “solution quality” evaluation is attached. The solution quality will be one of the following: Excellent, Good, Fair, Poor, No Solution. This evaluation provides the system operator with a quantifiable level of confidence that the correct solution has (or has not) been found.

### Echo Elimination

One of the primary sources of error in acoustic locating systems is the complicating factor of non-direct-line-of-sight signals, or echoes. The detection sensors cannot tell, a priori, whether a received signal is a direct line-of-sight signal or an echo. However, if the data from an echo signal is used in any location algorithm, then large errors in the calculated sniper position will result. It is imperative that echo signals be identified and eliminated from the Solution Sensor List. Fortunately, the Vigilante algorithm can easily and quickly perform this unique feat.

The advanced algorithm in Vigilante can automatically determine whether an individual sensor signal is a direct line-of-sight signal or an indirect echo signal. Echo signals (that would spoil the calculated sniper location) are automatically eliminated from the input data set.

The first indication that an echo signal has corrupted the solution is the value of the STE function at the solution point. If the absolute value is greater than about 10⁻² seconds, then it is likely that the data set contains an echo. This can be found quickly by examining the individual errors that make up the components of the STE function. Recall that this function is the summation of the absolute value of the difference between the theoretical time delay and the measured time delay of each sensor. It turns out that, if a sensor's acoustic signal is an echo signal, then its timing error will be one to four orders of magnitude larger than the timing errors of direct line-of-sight sensors. This makes it very easy for the Vigilante software to determine if a sensor has received an echo signal, and exactly which sensor that might be. The signal from this sensor is then tagged as an “echo”, and is deleted from the Solution Sensor List. If there is another sensor's information available, then that sensor's data is added to the Solution Sensor List, and a solution is found as usual. If no other sensor's data is available, then a solution can be found using only 5, 4 or 3 sensors. Finding a solution using the STE function takes approximately one (1) second. Finding additional solutions after eliminating echo signal's adds approximately one second for each sensor eliminated. In this way, the penalty for recalculating an accurate solution after eliminating echo signals is minimal.

### Adaptive Sensor Selection

Typically, acoustic signals will not be detected by all of the sensors in the array. This means that anywhere from 3 to 32 signals may be acquired. The Vigilante algorithm automatically uses the data from a carefully chosen subset of those signals that assures a high quality solution. In essence, the algorithm looks at the geographical position of each sensor that received a signal and selects a “well-dispersed” subset of the sensors. (Sensors that are closely spaced geographically are likely to produce a lower quality solution.)

### Inherently Robust System

A typical operational system will contain many more sensors than are necessary for accurate sniper location. For, example, a platoon of 20 soldiers might go into the field with only 12 soldiers equipped with sensors. Given that an accurate solution is best obtained with at least 4 sensors, as many as 8 of the sensors may malfunction, fail to hear the shot or receive echo signals, etc., and the sniper-locating ability of Vigilante will not be compromised.

### Anti-Spoofing Features

There are a few theoretical tactics that an enemy might use to attempt to defeat Vigilante. These tactics may include multiple snipers firing from different locations at precisely the same instant. Algorithms are currently in development to counter this type of tactic.

### Other System Enhancements

GPS Error Correction

All GPS systems have inherent errors in their calculated locations. Systemic errors (ones occurring in all sensors) will be eliminated from all relative locations of the sniper. However, these errors will still appear in absolute (GPS) locations.

Non-systemic errors (ones unique to each sensor) that occur in multiple sensors have a tendency to be cancelled out by the STE algorithm.

Even these small errors may be decreased by a calibration routine performed prior to the daily deployment of the system. Since the central processor contains its own GPS system, each sensor may be brought into immediate physical proximity to the central processor and the sensor's reported location recorded. Any errors in the sensor's GPS reading are then entered into a calibration table for that specific sensor. In the event of an acoustic event, the reported location of the sensor can be modified by the contents of the calibration table for that sensor. This will reduce even the small errors expected with today's GPS systems to an absolute minimum.

### Pinging

In order to accurately locate the sniper, GPS levels of position accuracy (whether WAAS enhanced or not) are inadequate. Vigilante therefore enhances the relative positional location of its sensors through the use of “pinging”.

Pinging is the use of pulses that are sent between the sensors to range each sensor with respect to the central computer. At the moment of an event, an electromagnetic signal is sent over the radio data link from the central computer to each sensor. This signal is then returned to the central computer, and the round trip transit time determines the accurate range from the central computer to each sensor. This technology (identical to laser rangefinders) is readily available in accuracies adequate to Vigilante's requirement. Note that a second ping, originating from any one of the sensors, may be employed to improve relative sensor location by providing “cross bearings” to each sensor.

### Sonic Velocity Calibration

All calculations within the Vigilante software are currently based on an assumed speed of sound that is fixed at 1087 feet per second. This value is only true under certain conditions (e.g., sea level in standard atmospheric conditions). That value will vary slightly, with temperature and wind being the most significant modifiers.

Rather than attempting to infer an actual speed of sound from measured parameters, an internal calibrator can be added to the central processor. This chamber will be exposed to the environment in which an acoustic event occurs. The chamber will contain a miniature ultrasonic emitter and detector, spaced a known, precise distance apart. At the time of the event, a brief ultrasonic pulse will be sent from the emitter to the receiver. The travel time will be measured, and a precise speed of sound can be determined for the exact conditions at the time of the event.

In another embodiment, a thermistor can be used to determine the velocity of the wind.

### Acoustically Complex Environments

The performance of acoustic location systems has typically been poor in acoustically complex environments, such as urban settings. The numerous opportunities for acoustic shielding and echoes by narrow streets and tall buildings have rendered most muzzle blast systems ineffective in this environment. However, it is precisely in this sort of complex environment that the advanced features of Vigilante will perform well. Vigilante's ability to identify and eliminate echoes will prevent the performance degradation that other systems experience.

Vigilante's ability to deploy numerous remote sensors (e.g., the sensors can be incorporated into tennis balls), without exposing personnel to sniper fire, can essentially saturate an area with sensors. This technique results in an extremely high probability of detecting direct signals and accurate solutions, even in the most complex of acoustic environments.

### Detection and Elimination of Supersonic Shockwave

When a sniper fires a high velocity (i.e., supersonic) bullet, a powerful acoustic shockwave is emitted by the bullet as it passes through the air. This shockwave is precisely the acoustic event that is detected by the shockwave detection systems. In contrast with these systems, this shockwave is both useless and potentially confounding to the Vigilante system. It is critical to Vigilante that this sonic event is not mistaken for the muzzle blast when calculating the location of the sniper.

There are two distinctive features that can be used to identify and eliminate supersonic shockwaves. First, in all cases of supersonic bullets, a distinctive “double event” will occur. This double event can be identified by an approximately constant time delay between the first event (the shockwave) and the second event (the muzzle blast) in all or most of the sensors. In all cases in which this sort of double event is detected, only the second event, the muzzle blast, will be reported by the sensors.

The second feature of the supersonic shockwave is its acoustic fingerprint. As can be seen in the FIG. 9, the shockwave (the left peak on the chart) shows two distinct features that can be used for its identification. First, it is symmetrical about the zero axis. Note that the muzzle blast (right peak) shows a distinct asymmetry about the zero axis (i.e., it's maximum positive value is measurably greater than its maximum negative value). Second, there are a distinctive set of low amplitude, low frequency sonic components that trail right behind the muzzle blast. These distinctive components do not trail behind the supersonic shockwave.

All of the features mentioned above will be used to distinguish shockwaves from muzzle blasts.

### Shockwave and Muzzle Blast Detection

Pattern recognition is a crucial aspect of a functioning sniper detection system. The ability to extract both the shockwave and the muzzle blast from background noise is essential for the correct operation of Vigilante. As the ambient acoustic environment becomes more noisy (as in an urban environment), this function becomes significantly more difficult. A very competent pattern recognition solution is therefore critical to Vigilante's operation in noisy or urban environments.

Since the muzzle blast and shockwave are short transient events that must be isolated from background noise and isolated in time in order to provide timing information to the Vigilante solver, wavelet analysis permits far superior recognition capabilities than traditional filtering or Fourier analysis methods.

The preferred method of detecting both the shockwaves and the muzzle blasts will be to use a broadband acoustic sensor, two bandpass-filtered channels of the input signal to enhance 1. the 100 Hertz muzzle blast component and 2. the 1000 Hz shockwave component, windowed Automatic Gain Control (AGC) to prevent signal saturation, and Undecimated Wavelet Transforms (UDTs) applied to both of these channels to distinguish shockwaves and muzzle blasts from background noise. The advantages of UDTs over standard Decimated Wavelet Transforms (DWTs) are: superior time resolution, superior de-noising and superior peak detection.

Note that the shockwaves are used solely for the purpose of alerting the system to potential events (i.e., bringing the system from low-power monitor to active mode). Finally, a library of custom muzzle blast wavelets can be generated and stored in electronic memory for comparison to real events from different rifles (e.g., AK47, AK74, AR15, etc) and to false events (e.g., car backfire, firecracker, etc.).

### Data Daisy Chain in Personal Defense System Sensors

It will be possible, at a cost in size and power consumption, to incorporate bidirectional data transfer capabilities into the sensors used in the Personal Defense System. It is possible for some troops (and their sensors) to wander far enough from the central processor (or to enter a radio blackout area) such that their direct radio link is severed.

The ability of each sensor to receive and rebroadcast tagged data sets from nearby sensors (in essence, to act as data repeaters) will effectively eliminate this possible limitation.

### Sonic Tripwire

In order to extend battery life of the Personal Defense System sensors, it is possible to have all sensors power down into a “standby” mode during most of their operation. In this mode, all sensors are simply listening for the sudden, initial report of a muzzle blast of a low velocity bullet or the supersonic shockwave of a high velocity bullet. In this mode, the computationally intensive and power draining operation of performing constant data collection, Fourier transforms, and digital fingerprinting of all sounds are suspended. However, all of these features are on-line and ready to be implemented in a few milliseconds. The alert signal can be transmitted to the central process and thereby to each sensor to begin data collection immediately. It is estimated that this wakeup process can be accomplished in approximately 30 milliseconds.

When any one of the sensors (typically the closest) detects a possible event, it awakens the entire system. In order to achieve this goal, the entire system must be on standby mode, capable of full performance in 25 milliseconds or less. The first sensor will have lost the acoustic signature of the muzzle blast, but any other sensor more than about 30 feet further from the origin of the blast will be awake & recording data when the sound arrives at its sensor. The sacrifice of one sensor's data is a small price to pay for a greatly improved battery life. And since there is such an abundance of redundancy built into the system, the loss of an acoustic fingerprint from one sensor will most likely be completely inconsequential to the performance of the system as a whole.

### Wind Correction

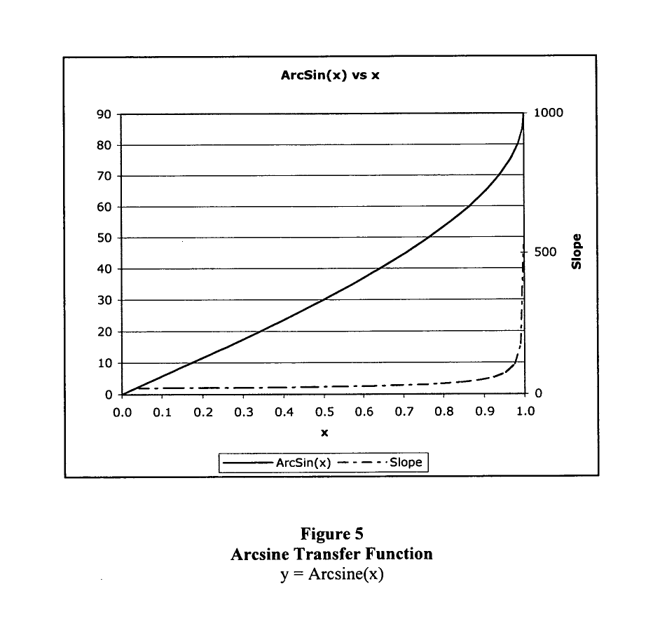

Wind is a formidable foe to precise calculations of the positional origin of the acoustic event. Nonetheless, it is a foe that can be tamed with appropriate modifications to the characteristic equation. Note that in the equation as described in FIG. 5, the velocity of sound was assumed to be a constant 1087 feet per second (or the value measured by the sonic velocity calibrator). With any wind, this value will be incorrect. Fortunately there is an easy way to compensate for winds. First, the central processor will be equipped with a small station whose sole function is to measure the wind speed and magnetic direction. It is assumed that the wind speed and direction is approximately constant over the entire volume of space being searched for the origins of the acoustic event. In reality, the wind speed and direction will vary slightly. But if the speed and velocity are even approximately constant (±30%), introduction of this correction will dramatically improve the accuracy of the system as a whole.

The simple mathematical technique to correct for wind is to modify sonic velocity by the component of the wind in the direction from the test point under consideration to each individual sensor. This correction is calculated as the dot product of the wind velocity vector and a unit vector pointing from the test point to each sensor. This gives, in essence, the component of the wind in the direction from the test point to each sensor. This velocity is added or subtracted from the standard (or measured) wind velocity in order to eliminate the errors that wind can generate in the answers.

### Signal Processing

Several standard signal processing steps can be incorporated into the sensors to improve recognition of acoustic signatures, reduce ambient noises, and improve the overall response of the system.

### Edge Enhancement

This technology simply increases the response of the system to the high frequency leading edge of the acoustic event by amplifying the time derivative of the sound level. This technique makes a sudden change in noise level stand out, even if the origin of the noise is far away and the actual amplitude of the noise is small. This technique will come in particularly handy for the “Sonic Tripwire” feature mentioned above.

### Fast Fourier Transforms

Fourier transformation applied to the “Sound Amplitude versus Time” chart of acquired data is the key first step in producing Frequency spectrum analysis of the sound data. Once the frequency spectrum of a recorded event has been determined, several sophisticated manipulations of the data may be implemented, including comparison of any measured frequency spectrum to a stored library of frequency profiles. This advanced feature would allow the system to identify the particular type of weapon that has been fired if that weapon's frequency spectrum has been included in the stored library.

### Tuned Digital Filter to Specific Weapon Frequency Spectrum

The unique acoustic fingerprints of several popular weapons can be determined. Tuned digital filters may then be applied to the recorded sonic waveform. These filters will greatly enhance the recognition of these weapons systems, especially in acoustically noisy environments.

### Ambient Noise Filtering

Filtering of ambient noise will be a key feature of Vigilante that will allow it to recognize the distinct acoustic signature of a muzzle blast amidst the cacophony of a typical outdoor environment. One particularly valuable technique would be the use of an “inversion, filtering and addition” stage to the amplified acoustic signature. In this technique, the input signal is acquired and inverted. The input frequencies of interest are then filtered out of the original signal only. Then the two signals are added together. The result is an output equal to zero for all frequencies except the frequencies of interest.

### Means to Eliminate Zones of Imprecision of Crossed Pairs of Microphones

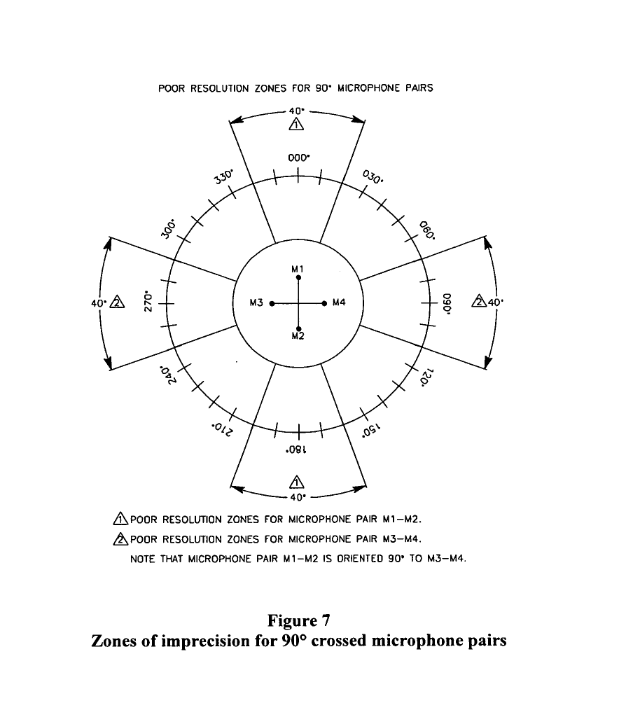

As shown in FIG. 7, there are four large areas of imprecision that result from the use of crossed pairs of microphones. The zones of imprecision are −20° to 20°, 70° to 110°, 160° to 200° and 250° to 290°. The following paragraphs describes a simple way to avoid these imprecise zones. As a bonus, the system is simplified to the use of three sensors instead of four.

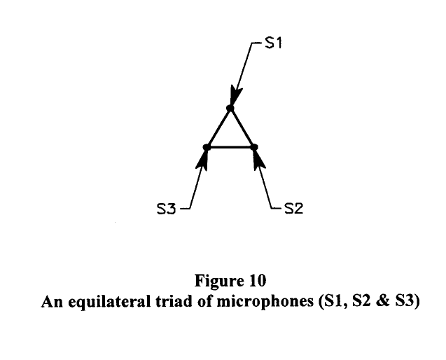

As mentioned, the accuracy of any pair of microphones decreases when the bearing angle is in the range of 250°<Ø<290° (which is equivalent to −110°<Ø<−70°) or 70°<Ø<110° for any given microphone pair. The solution is to not use the calculated results if the bearing angle exceed ±60° for any given pair of sensors. From 0° to 60°, the arcsine function is actually well-behaved, as can be seen in FIG. 5. The solution to always having two bearing measurements that fall into this well-behaved range is to arrange the microphones into an equilateral triangle of three sensors as shown in FIG. 10. If we overlay the standard zones of imprecision onto this triad, the orientation shown in FIG. 10 is obtained.

Note that the zones do not overlap. This means that at any bearing angle, two pairs of sensors can be used for which the bearing angle will be equal to or less than 60°. As shown in FIG. 5, keeping the bearing angles below this value results in a well-behaved transfer function, and the elimination of the four zones of imprecision noted earlier. In operation, a system using this triad will calculate three separate solutions for the position of any recorded event using all three permutations of the three sensors taken two pairs at a time. Solution 1 will use S1S2 & S1S3. Solution 2 will use S1S2 & S2S3. And solution 3 will use S1S3 & S2S3. After the solutions have been calculated, the two solutions generated by the forbidden pair of sensors are cast aside as being inaccurate. For example, assume the following solutions were obtained using the three pairs of sensors (in conjunction with a fourth and fifth pair of sensors, of course).

TABLE 4
Calculated bearing and range with sensor triad

| Sensor Pairs used | Calculated bearing angle | Calculated range |
|---|---|---|
| S1S2 & S1S3 | 21° | 235 m |
| S1S2 & S2S3 | 24° | 272 m |
| S1S3 & S2S3 | 29° | 221 m |

Since the bearing angles all turned out to be in the range of 0° to 60°, sensor pair S1S3 is the forbidden pair. This means that solutions that use this sensor pair (the first and third solutions listed in Table 4) are eliminated, and the second solution is reported. Note that the bearing of this solution from sensor pair S1S2 is approximately −36°, and the relative bearing to sensor pair S2S3 is 24°. Both of these values are, as predicted, between the accurate bearings of −70<Ø<70°. The relative bearing of this solution to sensor pair S1S3 is however equal to 84°, well above the accuracy limiting bearing of 70°.

Note that, with an equilateral triangle of sensors, there is guaranteed to be a valid pair of sensors for any bearing angle between 0° and 360°.

Note that, while this discussion has analyzed only a horizontal plane, the principles described are easily extendible to the third, vertical dimension.

Note that, while the triad (i.e., equilateral triangle) configuration of microphones is simplest and lowest microphone count configuration that avoids the problem of excess sensitivity in the “forbidden” ranges, several other possible configurations using 4, 5, 6, 7 or 8 microphones is possible. The appropriate way to configure all of these systems is to orient one pair of microphones such that it's axis makes an angle of less than 70° with the other pair (or pairs) of microphones.

One example of an acceptable sensor orientation for various numbers of microphones is a circular orientation.

### Additional Aspects of the Invention

1) A system of widely spaced sensors connected by hardwire or radio link to a central processor that is loaded with a specialized software program that permits the location of the origin of a sudden acoustic event.
2) A system in which each sensor contains an omnidirectional microphone, GPS input capability and signal processing to distinguish acoustic events of interest from background noise.
3) A system in which the sensors are not fixed in space relative to each other, but free to roam.
4) A system in which the specific location of the sensor is determined at the time of the acoustic event.
5) A system in which each sensor in the array is a single microphone rather than a subarray of two or more microphones.
6) A system in which each sensor can transmit to the central processor by radio or hardwire link its instantaneous position at the moment the sound from the event arrived at the sensor and a precise time of that arrival.
7) A system in which an auxiliary set of GPS and radio equipped sensors may be randomly deployed by individuals at a critical moment (e.g., after receiving a single sniper shot) in order to increase the probability of locating a subsequent acoustic event.
8) A system in which the various sensors can pass along tagged information from adjacent sensors to other adjacent sensors, and thereby to the central processor even when it is out of direct radio range with the central processor.
9) A system in which the central processor can input the data transmitted by the several sensors and sound an alarm to attendant personnel announcing the acoustic event.
10) A system in which the central processor can rapidly use the time and location information from all or a subset of the sensors to accurately calculate the positional origin of the acoustic event.
11) A system in which the central processor can calculate the positional origin of the acoustic event without using the microphone' data in predetermined pairs.
12) A system in which the central processor can calculate the positional origin of the acoustic event without using trigonometric relationships (or their discrete mathematical approximations) applied to pairs of microphone data.
13) A system that possesses approximately uniform sensitivity and accuracy throughout the full 360° of bearing angle.
14) A system in which the central processor can calculate the positional origin of the acoustic event without calculating direction vectors to the sound.
15) A system in which the central processor can calculate the positional origin of the sound without calculating the intersection of multiple direction vectors.
16) A system in which the central processor constructs at the moment of an acoustic event a unique characteristic equation defining the positions of the various sensors and times of arrival of the sound at each sensor.
17) A system in which the {x,y,z} values of that characteristic equation represent the physical space in which the sensors are located.
18) A system in which a minimal value or maximal value of that characteristic represents the most probable location of the source of the acoustic event.
19) A system in which the central processor then proceeds to search for minimal (or maximal) values of that characteristic equation in order to find the most probable positional origin of that acoustic event.
20) A system in which back substitution of the initial solution is used to look for errors in the timing signals of individual sensors (i.e., time delays are too long), indicating that those timing signals were not direct line-of-sight signals, but echoes.
21) A system in which any echo signals are automatically removed from the raw data set, the data is replaced with another sensor data, and the solution is recalculated.
22) A system that can scan the full data set of sensor information available to it and choose a superior subset of that data based on appropriate geographical locations of the sensors.
23) A system that can use an initial calculated solution based on one subset of the full data set and then recalculate a superior solution by using a different, but superior, subset of the data.
24) A system that can use the absolute value of the minimum (or maximum) of the characteristic equation to provide a “figure of merit” to the solution.
25) A system that then provides that figure of merit to its operator to assist in choosing an appropriate tactical response to the acoustic event.
26) A system in which the relative range, bearing and azimuth (or elevation) of the calculated positional origin of the acoustic event is graphed on a display screen.
27) A system in which the absolute (i.e., GPS) location of the positional origin of the acoustic event is enumerated on a display screen.
28) A system in which the position of all remote sensors are graphed on a display screen.
29) A system in which the precise, individual relative range, bearing and azimuth vector from each of the closest subset of friendly, sensor bearing assets to the origin of the positional origin is enumerated on a display screen.
30) A system in which the precise location of a second explosive event (e.g., a retaliatory grenade explosion) can be precisely calculated in the same manner as the original acoustic event.
31) A system in which the location of the first and second event can be compared, and the spacing between those events enumerated on the display screen.
32) A system in which the central processor possesses a calibration device that measures the speed of sound in its own environment and then uses that measurement in its calculations instead of an assumed constant.
33) A system in which means are employed on the central processor to calculate wind speed and direction at the moment of the acoustic event in order to apply those corrections to the internal calculations and reduce errors due to ambient winds.
34) A system in which an auxiliary locating means is incorporated into each sensor, such as an ultrasonic emitter and detector, that can improve sensor location information beyond the resolution of GPS systems.
35) A system in which the central processor calibrates each individual sensor, constructing a lookup table of sensor position errors, in order to eliminate systemic errors from each sensor when calculating positional origins of acoustic events.
36) A system in which the central processor can provide digital information for the calculated positional origin of the acoustic event to other remote control devices.
37) A system in which the central processor can control one or more remote control devices, such as cameras, lights or telescopes, training each onto the specific calculated positional origin of the acoustic event.
38) A system in which the central controller can initiate the recording of photographic or video data as soon as an acoustic event is detected.
39) A system that can incorporate an array of pressure sensing devices alongside an array of acoustic sensors.
40) A system that can record the magnitude of the pressure wave at each pressure sensor.
41) A system that can calculate the positional origin of an explosive event in the midst of, or adjacent to, the array of acoustic sensors.
42) A system that can use the apparent magnitude of the pressure wave at each sensor and the calculated positional origin of the explosion (thereby knowing the distance between the explosion and the pressure sensors) to calculate the absolute magnitude of an explosion.
43) A triad configuration of sensors for use with systems that employ closely spaced, fixed sensors arranged in an equilateral triangle that would eliminate the four zones of imprecision that are inherent with the use of crossed pairs of sensors.
44) A five, six, seven or eight microphone configuration

What is claimed is:

1. A system for detecting the exact location of an acoustic event, the system comprising:
a plurality of variably spaced sensors, wherein each sensor comprises:
an omnidirectional microphone for detecting the acoustic event;
a global positioning system (GPS); and
a transmitter receiver for transmitting (i) the time that the acoustic event arrived at a particular sensor and (ii) the location of the particular sensor at the time the acoustic event arrived at the particular sensor; and
a central processor radio-linked to the plurality of variably spaced sensors comprising a software program comprising at least one algorithm for determining the location of the acoustic event.

2. A method for detecting the exact location of an acoustic event, the method comprising:
providing a system comprising:
a plurality of variably spaced sensors, wherein each sensor comprises:
an omnidirectional microphone for detecting the acoustic event;
a global positioning system (GPS); and
a transmitter receiver for transmitting (i) the time that the acoustic event arrived at a particular sensor and (ii) the location of the particular sensor at the time the acoustic event arrived at the particular sensor; and
a central processor radio-linked to the plurality of variably spaced sensors comprising a software program comprising at least one algorithm for determining the location of the acoustic event;
transmitting (i) the time the acoustic event arrived at the particular sensor and (ii) the location of the particular sensor at the time the acoustic event arrived at the particular sensor to the central processor;
applying a first algorithm to the time and location of the particular sensor to generate an approximate location of the acoustic event; and
applying a second algorithm to the time and location of the particular sensor to detect the exact location of the acoustic event.
